(19) United States
(12) Patent Application Publication
(10) Pub. No.: US 2023/0011094 A1
(43) Pub. Date: Jan. 12, 2023

(54) User Interface for Real-time Online Payment User Input

(71) Applicant: Ayaka Yamamoto, Atlanta, GA (US)

(72) Inventor: Ayaka Yamamoto, Atlanta, GA (US)

(21) Appl. No.: 17/305,530

(22) Filed: Jul. 9, 2021

(51) Int. Cl. G06F 3/0486; G06Q 20/10; G06F 3/0484

(52) U.S. Cl. CPC G06F 3/0486; G06Q 20/10; G06F 3/04847; G06Q 20/29

(57) ABSTRACT

A user interface that captures the user input of payment amount during real-time online events (e.g. live podcasts, live stream videos, online games). The user utilizes their personal computer or mobile device to drag a graphic object displayed in the user interface. The amount of fund to be sent is proportional to the time length of the user's drag motion. The user interface allows users to control the input value by timing the release of the graphic object. Further, a component to display count up of input value may be utilized as part of the user interface to provide user feedback.

### CROSS-REFERENCE TO RELATED APPLICATIONS

Not Applicable

### STATEMENT REGARDING FEDERALLY SPONSORED RESEARCH OR DEVELOPMENT (IF APPLICABLE)

Not Applicable

### REFERENCE TO SEQUENCE LISTING, A TABLE, OR A COMPUTER PROGRAM LISTING COMPACT DISC APPENDIX (IF APPLICABLE)

Not Applicable

### BACKGROUND OF THE INVENTION

Current or prior solutions to capture user input value for online payment include numerical keyboard input, button input with pre-fixed options, and slider input with selectable values displayed in a range along a bar. Either instruments provide enough usability for the users who want quick, intuitive and friction-less experience in utilizing digital applications. Common usability issues include user mistyping the digit and taking time to amend the error by keyboard input, pre-fixed options not including the value the user wanted to select, and range selector requiring pixel-precise position targeting makes it hard for users to calibrate on small devices.

This invention is an application of a drag-and-drop feature in GUI to solve the online payments usability issues, focusing on real-time use cases including micropayment transactions. CPC Classifications: G06Q 20/29 Micropayment, G06F 3/0486 Drag-and-drop

### BRIEF SUMMARY OF THE INVENTION

A user interface that captures the user input of payment amount during real-time online events (e.g. live podcasts, live stream videos, online games). It can be utilized by the content creator or the personnel who is broadcasting the media to accept online donations or facilitate crowdfunding campaigns. It can also be utilized in online games to determine the amount of virtual currencies the player wants to commit for actions (e.g. determine betting amount in poker).

The current or prior methods for capturing payment amount, such as numerical keyboard input, were designed for slow-and-sure use cases (e.g. one-time donation to a charity organization). However, the innovation in micropayment systems combined with advancement of network speed has opened up possibilities of new use cases including small online payments in real-time, therefore, a faster and more intuitive method is desired.

With this invention, the user utilizes their personal computer or mobile device to drag a graphic object displayed in the screen. The amount of fund to be sent is proportional to the time length of the user's drag motion—from the time they grabbed the graphic object to the time they released it. The calculated amount is displayed in the screen for user feedback.

This invention solves the usability issues identified in the previous section because the control mechanics is similar to using water faucet—the amount of water released is proportional to the time length the faucet was left open, which is second nature to most people. Compared to conventional solutions, this invention requires less user touch points on the screen, thus providing a smooth digital experience for users.

### BRIEF DESCRIPTION OF THE SEVERAL VIEWS OF THE DRAWING

FIG. 1 is a flow chart illustrating an exemplary method of creating a user interface providing user control of online payment amount on a webpage.

FIG. 2 is a component block diagram illustrating an embodiment of an exemplary user interface providing user control of online payment amount on a webpage.

FIG. 3 is a component block diagram illustrating second embodiment of an exemplary user interface providing user control of online payment amount on a webpage.

### DETAILED DESCRIPTION OF THE INVENTION

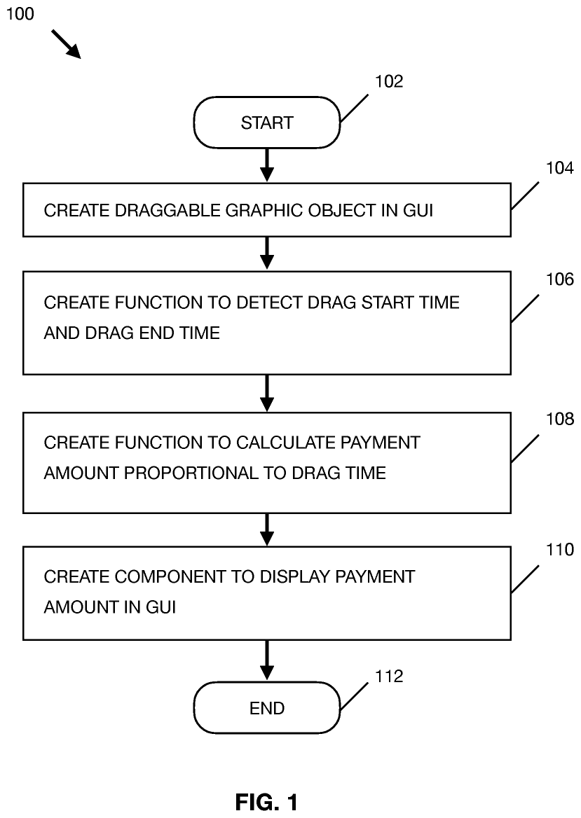

FIG. 1 is a flow chart illustrating an exemplary method 100 for creating an interface for users to control the amount they want to pay on a webpage or an application. The exemplary method 100 begins at 102. The first step is to create a draggable graphic object in GUI, at 104. The graphic object can be an image file or a geographic shape expressed by programming languages (e.g. CSS). Furthermore, it can be in the form of 2D or 3D graphics for applications such as virtual reality and augmented reality. The techniques and systems described herein are not limited to one particular technique for creating a draggable graphic object in GUI.

The next step is to create a function that detects when the user started dragging the graphic object and when the user ended the drag motion, at 106. An application program interface (API) can be utilized to detect user operation controlled by a mouse, a touch device and other human-machine interfaces (HMI). At 108, a function to calculate the payment amount based on drag time detected at 106 is created in code. The payment amount is calculated proportionally to the time length of drag. For example, the drag event with the time length of 1 second, 2 seconds, 3 seconds can respectively be translated to the user selected payment amount of 10 cents, 20 cents, 30 cents.

At 110, a component to display the payment amount calculated at 108 is created in a section of the GUI. In this example, the section displays the interval value that counts upwards from zero during the drag event. In this way, user receives a visual feedback of the incrementing value and understands when they should stop the drag event in order to adjust the payment amount.

Having allowed the user interface to control the user input of payment amount, the exemplary method 100 ends at 112.

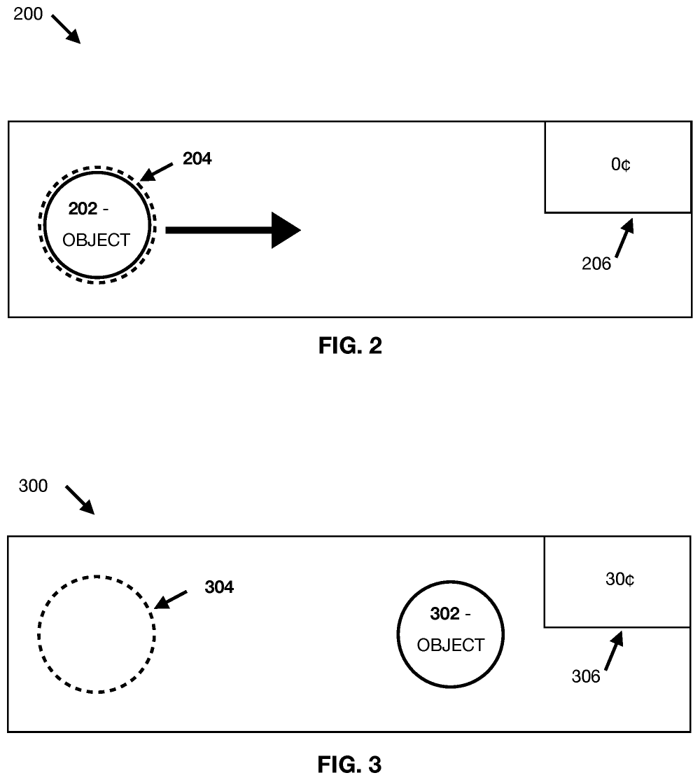

FIG. 2 illustrates an exemplary embodiment 200 of a user interface (UI) that allows users to control the input value of online payment on a webpage. In the exemplary embodiment 200, the UI contains a draggable graphic object 202, created at 104, contained inside a frame 204 that marks the original position of the draggable graphic object. In this example, the draggable graphic object 202 is dragged by a user to an area outside of the frame 204. The component 206, created at 110, displays the input value counting upwards from zero.

FIG. 3 is an illustration of another exemplary embodiment 300 of a user interface (UI) (200 in FIG. 2) after the user initiated the drag event. The draggable graphic object 302 (202 in FIG.2) is held outside of the frame 304 (204 in FIG.2) by the user. The component 306 displays the input value counting upwards until the user releases the graphic object 302 and finalizes the input value by ending the drag event. In this example, the user held the object 302 outside of the frame 304 for three seconds so that the final input value would be 30¢.

1. A method for providing user control of real-time online payment amount on a graphical user interface (GUI) of a computing device:
creating a draggable graphic object in GUI framed by a closed shape as a visual guideline to indicate the origin of the draggable object;
displaying the updated location of the draggable object which is moved and held outside of the closed shape in response to user input corresponding to drag;
utilizing the time duration of the graphic object being dragged to determine the transaction amount;
displaying an incremental value of transaction amount while the draggable object is being held outside of the closed shape;
displaying the draggable object popping back into the closed shape in response to user input corresponding to release;
and finalizing the transaction amount upon user input corresponding to release.

2. The method of claim 1, wherein the draggable graphic object includes 3D graphics in virtual reality and augmented reality applications.

3. The method of claim 1, wherein the user input includes input via a non-touch screen (such as keyboard, keypad, mouse, video game controller etc.).

4. The method of claim 1, wherein the transaction amount is determined by the time length of the object being held outside of the closed shape.

5. The method of claim 1, further comprising displaying multiple draggable objects with different increment variables to determine the transaction amount.
